(19) United States
(12) Patent Application Publication
(10) Pub. No.: US 2021/0396962 A1
(43) Pub. Date: Dec. 23, 2021

(54) CAMERA LENS

(71) Applicant: AAC Optics Solutions Pte. Ltd., Singapore City (SG)

(72) Inventors: Koji Nitta, OSAKA (JP); Hiroyuki Teraoka, OSAKA (JP)

(21) Appl. No.: 16/916,167

(22) Filed: Jun. 30, 2020

(30) Foreign Application Priority Data
Jun. 23, 2020 (JP) 2020-108213

(51) Int. Cl. G02B 13/00; G02B 9/64; G02B 13/06; G02B 27/00

(52) U.S. Cl. CPC G02B 13/0045; G02B 27/0025; G02B 13/06; G02B 9/64

(57) ABSTRACT

The present invention provides a camera lens consisting of seven lenses and having a small height, a wide angle, and good optical characteristics. The camera lens includes, sequentially from an object side, a first lens having a positive refractive power, a second lens having a negative refractive power, a third lens having a positive refractive power, a fourth lens having a negative refractive power, a fifth lens having a negative refractive power, a sixth lens having a positive refractive power, and a seventh lens having a negative refractive power. The camera lens satisfies specific conditions.

### TECHNICAL FIELD

The present invention relates to a camera lens, and particularly, to a camera lens consisting of seven lenses, suitable for portable module cameras that adopt high-pixel Charge Coupled Device (CCD), Complementary Metal-Oxide Semiconductor Sensor (CMOS), or other imaging elements, and having a small height of TTL (a total optical length)/IH (an image height)≤1.30, a wide angle (i.e., a full field of view, hereinafter referred to as 2ω) above 80° and good optical characteristics.

### BACKGROUND

In recent years, various camera devices using imaging elements such as CCDs and

CMOSs are widely applied. With the development of these imaging elements towards miniaturization and high performance, it is desired to provide a camera lens with a small height, a wide angle, and good optical characteristics.

The technologies related to the camera lens consisting of seven lenses and having a small height, a wide angle, and good optical characteristics are under development. As a camera lens having a seven-lens structure, a camera lens provided in the related art includes a first lens having a positive refractive power, a second lens having a negative refractive power, a third lens having a positive refractive power, a fourth lens having a negative refractive power, a fifth lens having a negative refractive power, a sixth lens having a positive refractive power, and a seventh lens having a negative refractive power, sequentially arranged from an object side.

Regarding the camera lens disclosed in the related art, a distortion of a maximum image height, a difference between abbe numbers of the first lens and the second lens, a difference between abbe numbers of the first lens and the fourth lens, a ratio of a focal length of the first lens to a focal length of the second lens, and a refractive power distribution of the fifth lens are insufficient, so that the height reduction is insufficient.

### SUMMARY

An object of the present invention is to provide a camera lens consisting of seven lenses and having a small height, a wide angle, and good optical characteristics.

For the above object, a distortion of a maximum image height, a difference between abbe numbers of the first lens and the second lens, a difference between abbe numbers of the first lens and the fourth lens, a ratio of a focal length of the first lens to a focal length of the second lens, and a refractive power distribution of the fifth lens have been intensively studied, and it is found that a camera lens of the present invention can solve the technical problems in the related art.

A camera lens according to a first technical solution sequentially includes, from an object side, a first lens having a positive refractive power, a second lens having a negative refractive power, a third lens having a positive refractive power, a fourth lens having a negative refractive power, a fifth lens having a negative refractive power, a sixth lens having a positive refractive power, and a seventh lens having a negative refractive power. The camera lens satisfies following conditions:

5.00≤DMI≤15.00;

50.00≤v1−v2≤70.00;

50.00≤v1−v4≤70.00;

−0.35≤f1/f2≤−0.15; and

−2.00≤f5/f≤−0.50,
where DMI denotes a distortion of a maximum image height;
v1 denotes an abbe number of the first lens;
v2 denotes an abbe number of the second lens;
v4 denotes an abbe number of the fourth lens;
f denotes a focal length of the camera lens;
f1 denotes a focal length of the first lens;
f2 denotes a focal length of the second lens; and
f5 denotes a focal length of the fifth lens.

The camera lens according to a second technical solution further satisfies a following condition:

−5.00≤R9/R10≤−0.20,
where R9 denotes a curvature radius of an object side surface of the fifth lens; and
R10 denotes a curvature radius of an image side surface of the fifth lens.

The camera lens according to a third technical solution further satisfies a following condition:

0.02≤R1/R2≤0.35,
where R1 denotes a curvature radius of an object side surface of the first lens; and

R2 denotes a curvature radius of an image side surface of the first lens.

According to the present invention, particularly provided is a camera lens consisting of seven lenses, suitable for portable module cameras that adopt high-pixel CCD, CMOS, or other imaging elements, having a small height of TTL (total optical length)/IH (image height)≤1.30, capable of guaranteeing a wide angle of 2ω>80°, and also having good optical characteristics.

### BRIEF DESCRIPTION OF DRAWINGS

FIG. 1 is a schematic diagram showing an overview of structure of a camera lens LA according to a first embodiment of the present invention;

FIG. 2 is diagrams of a spherical aberration, a field curvature, a distortion of the camera lens LA according to the first embodiment of the present invention;

FIG. 3 is a schematic diagram showing an overview of structure of a camera lens LA according to a second embodiment of the present invention;

FIG. 4 is diagrams of a spherical aberration, a field curvature, a distortion of the camera lens LA according to the second embodiment of the present invention;

FIG. 5 is a schematic diagram showing an overview of structure of a camera lens LA according to a third embodiment of the present invention;

FIG. 6 is diagrams of a spherical aberration, a field curvature, a distortion of the camera lens LA according to the third embodiment of the present invention;

FIG. 7 is a schematic diagram showing an overview of structure of a camera lens LA according to a fourth embodiment of the present invention;

FIG. 8 is diagrams of a spherical aberration, a field curvature, a distortion of the camera lens LA according to the fourth embodiment of the present invention;

FIG. 9 is a schematic diagram showing an overview of structure of a camera lens LA according to a fifth embodiment of the present invention; and

FIG. 10 is diagrams of a spherical aberration, a field curvature, a distortion of the camera lens LA according to the fifth embodiment of the present invention.

### DESCRIPTION OF EMBODIMENTS

The embodiments of the camera lens according to the present invention will be described below. The camera lens LA is provided with a lens system. The lens system has a seven-lens structure and includes a first lens L1, a second lens L2, a third lens L3, a fourth lens L4, a fifth lens L5, a sixth lens L6, and a seventh lens L7, arranged from an object side to an image side. A glass plate GF is arranged between the seventh lens L7 and an image plane. A cover glass plate or any of various filters can be used as the glass flat plate GF. In the present invention, the glass plate GF may be arranged at different positions, or may also be omitted.

The first lens L1 is a lens having a positive refractive power, the second lens L2 is a lens having a negative refractive power, the third lens L3 is a lens having a positive refractive power, the fourth lens L4 is a lens having a negative refractive power, the fifth lens L5 is a lens having a negative refractive power, the sixth lens L6 is a lens having a positive refractive power, and the seventh lens L7 is a lens having a negative refractive power. In order to correct various aberrations, it is desirable to design all surfaces of these seven lenses as aspherical surfaces.

The camera lens LA satisfies the following conditions (1) to (5):

5.00≤DMI≤15.00 (1);

50.00≤v1−v2≤70.00 (2);

50.00≤v1−v4≤70.00 (3);

0.35≤f1/f2≤−0.15 (4); and

−2.00≤f5/f≤−0.50 (5),
where DMI denotes a distortion of a maximum image height;
v1 denotes an abbe number of the first lens;
v2 denotes an abbe number of the second lens;
v4 denotes an abbe number of the fourth lens;
f denotes a focal length of the camera lens;
f1 denotes a focal length of the first lens;
f2 denotes a focal length of the second lens; and
f5 denotes a focal length of the fifth lens.

The condition (1) specifies the distortion of the maximum image height. If the distortion is below the lower limit of the condition (1), although correction of aberrations becomes easier, height reduction becomes more difficult, which is thus not preferable. If the distortion is above the upper limit of the condition (1), although it facilitates the height reduction, the correction of aberrations becomes more difficult, which is not preferable.

The condition (2) specifies a difference between the abbe number v1 of the first lens L1 and the abbe number v2 of the second lens L2. If it is within the range of the condition (2), correction of on-axis and off-axis aberrations becomes easier with the small height, which is preferable.

The condition (3) specifies a difference between the abbe number v1 of the first lens L1 and the abbe number v4 of the fourth lens L4. If it is within the range of the condition (3), correction of on-axis and off-axis aberrations becomes easier with the small height, which is preferable.

The condition (4) specifies a ratio of the focal length f1 of the first lens L1 to the focal length f2 of the second lens L2. If it is within the range of the condition (4), correction of on-axis and off-axis aberrations becomes easier with the small height, which is preferable.

The condition (5) specifies a negative refractive power for the fifth lens L5. If it is within the range of the condition (5), correction of on-axis and off-axis aberrations becomes easier with the small height, which is preferable.

The fifth lens L5 has the negative refractive power, and satisfies the following condition (6):

−5.00≤R9/R10≤−0.20 (6),
where R9 denotes a curvature radius of an object side surface of the fifth lens; and
R10 denotes a curvature radius of an image side surface of the fifth lens.

The condition (6) specifies a ratio of the curvature radius R9 of the object side surface of the fifth lens L5 to the curvature radius R10 of the image side surface of the fifth lens L5. If it is within the range of condition (6), correction of the aberrations becomes easier with the small height, which is preferable.

The first lens L1 has a positive refractive power, and satisfies the following condition (7):

0.02≤R1/R2≤0.35 (7),
where R1 denotes a curvature radius of an object side surface of the first lens; and
R2 denotes a curvature radius of an image side surface of the first lens.

The condition (7) specifies a ratio of the curvature radius R1 of the object side surface of the first lens L1 to the curvature radius R2 of the image side surface of the first lens L1. If it is within the range of condition (7), correction of the aberrations becomes easier with the small height, which is preferable.

The seven lenses of the camera lens LA satisfy the above configurations and conditions, so as to obtain the camera lens consisting of seven lenses, having a small height of TTL (a total optical length)/IH (an image height)≤1.30, capable of guaranteeing a wide angle of 2ω>80°, and also having good optical characteristics.

### EMBODIMENTS

The camera lens LA of the present invention will be described with reference to the embodiments below. The reference signs described in the embodiments are listed below.

In addition, the distance, radius and center thickness are all in a unit of mm.

f: focal length of the camera lens LA;

f1: focal length of the first lens L1;

f2: focal length of the second lens L2;

f3: focal length of the third lens L3;

f4: focal length of the fourth lens L4;

f5: focal length of the fifth lens L5;

f6: focal length of the sixth lens L6;

f7: focal length of the seventh lens L7;

Fno: F number;

2ω: full field of view;

S1: aperture;

R: curvature radius of an optical surface, a central curvature radius for a lens;

R1: curvature radius of an object side surface of the first lens L1;

R2: curvature radius of an image side surface of the first lens L1;

R3: curvature radius of an object side surface of the second lens L2;

R4: curvature radius of an image side surface of the second lens L2;

R5: curvature radius of an object side surface of the third lens L3;

R6: curvature radius of an image side surface of the third lens L3;

R7: curvature radius of an object side surface of the fourth lens L4;

R8: curvature radius of an image side surface of the fourth lens L4;

R9: curvature radius of an object side surface of the fifth lens L5;

R10: curvature radius of an image side surface of the fifth lens L5;

R11: curvature radius of an object side surface of the sixth lens L6;

R12: curvature radius of an image side surface of the sixth lens L6;

R13: curvature radius of an object side surface of the seventh lens L7;

R14: curvature radius of an image side surface of the seventh lens L7;

R15: curvature radius of an object side surface of the glass plate GF;

R16: curvature radius of an image side surface of the glass plate GF;

d: center thickness or distance between lenses;

d0: on-axis distance from the aperture S1 to the object side surface of the first lens L1;

d1: center thickness of the first lens L1;

d2: on-axis distance from the image side surface of the first lens L1 to the object side surface of the second lens L2;

d3: center thickness of the second lens L2;

d4: on-axis distance from the image side surface of the second lens L2 to the object side surface of the third lens L3;

d5: center thickness of the third lens L3;

d6: on-axis distance from the image side surface of the third lens L3 to the object side surface of the fourth lens L4;

d7: center thickness of the fourth lens L4;

d8: on-axis distance from the image side surface of the fourth lens L4 to the object side surface of the fifth lens L5;

d9: center thickness of the fifth lens L5;

d10: on-axis distance from the image side surface of the fifth lens L5 to the object side surface of the sixth lens L6;

d11: center thickness of the sixth lens L6;

d12: on-axis distance from the image side surface of the sixth lens L6 to the object side surface of the seventh lens L7;

d13: center thickness of the seventh lens L7;

d14: on-axis distance from the image side surface of the seventh lens L7 to the object side surface of the glass plate GF;

d15: center thickness of the glass plate GF;

d16: on-axis distance from the image side surface of the glass plate GF to the image plane;

nd: refractive index of d line;

nd1: refractive index of d line of the first lens L1;

nd2: refractive index of d line of the second lens L2;

nd3: refractive index of d line of the third lens L3;

nd4: refractive index of d line of the fourth lens L4;

nd5: refractive index of d line of the fifth lens L5;

nd6: refractive index of d line of the sixth lens L6;

nd7: refractive index of d line of the seventh lens L7;

ndg: refractive index of d line of the glass plate GF;

v: abbe number;

v1: abbe number of the first lens L1;

v2: abbe number of the second lens L2;

v3: abbe number of the third lens L3;

v4: abbe number of the fourth lens L4;

v5: abbe number of the fifth lens L5;

v6: abbe number of the sixth lens L6;

v7: abbe number of the seventh lens L7;

vg: abbe number of the glass plate GF;

TTL: total optical length (on-axis distance from the object side surface of the first lens L1 to the image plane); and

LB: on-axis distance from the image side surface of the seventh lens L7 to the image plane (including the thickness of the glass plate GF).

y=(x²/R)/[1+{1−(k+1)(x²/R²)}^{1/2}]+A4x⁴+A6x⁶+A8x⁸+A10x¹⁴+A12x¹²+A14x¹⁴+A16x¹⁶+A18x¹⁸+A20x²⁰ (8)

For convenience, the aspheric surface of each lens surface uses the aspheric surface defined in Equation (8). However, the present invention is not limited to the aspherical polynomial defined in Equation (8).

### First Embodiment

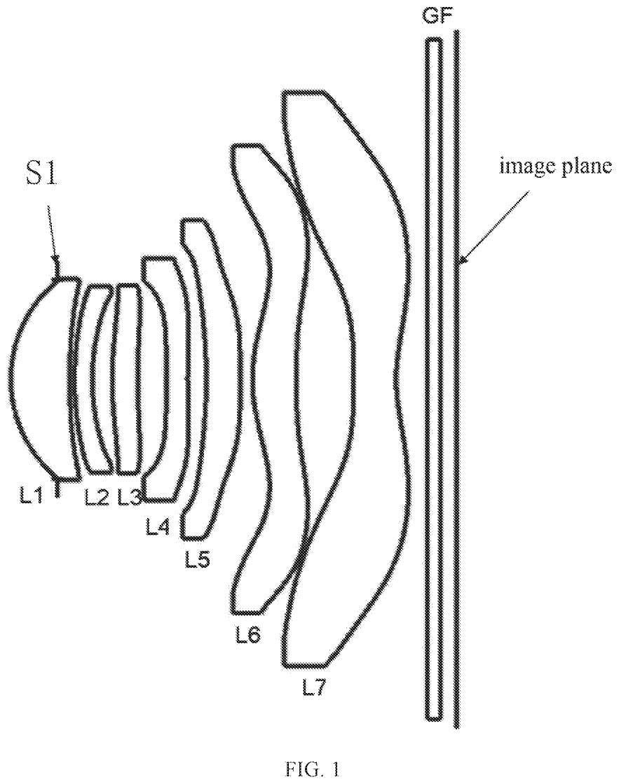

FIG. 1 is a schematic diagram showing a configuration of a camera lens LA according to a first embodiment of the present invention. The curvature radiuses R of the image side surfaces and object side surfaces of the first lens L1 to the seventh lens L7 of the camera lens LA according to the first embodiment, the center thicknesses of the lenses, or distances d between the lenses, refractive indexes nd, abbe numbers v are shown in Table 1; conic coefficients k and aspheric coefficients are shown in Table 2; and 2ω, Fno, f, f1, f2, f3, f4, f5, f6, f7, TTL, and IH are shown in Table 3.

TABLE 1

| | | | | | | | | Effective |
|---|---|---|---|---|---|---|---|---|
| | R | d | | nd | | ν d | | Radius(mm) |
| S1 | ∞ | d0= | −0.752 | | | | | |
| R1 | 2.16604 | d1= | 0.949 | nd1 | 1.4387 | ν 1 | 94.66 | 1.649 |
| R2 | 10.56602 | d2= | 0.080 | | | | | 1.577 |
| R3 | 5.10216 | d3= | 0.285 | nd2 | 1.6251 | ν 2 | 24.72 | 1.531 |
| R4 | 3.39850 | d4= | 0.322 | | | | | 1.410 |
| R5 | 6.08184 | d5= | 0.413 | nd3 | 1.5438 | ν 3 | 56.03 | 1.410 |
| R6 | 11.23268 | d6= | 0.458 | | | | | 1.550 |
| R7 | 106.80888 | d7= | 0.350 | nd4 | 1.6251 | ν 4 | 24.72 | 1.603 |
| R8 | 23.38243 | d8= | 0.299 | | | | | 1.994 |
| R9 | −8.31729 | d9= | 0.544 | nd5 | 1.5661 | ν 5 | 37.71 | 2.219 |
| R10 | 40.57216 | d10= | 0.198 | | | | | 2.611 |
| R11 | 2.61797 | d11= | 0.712 | nd6 | 1.5438 | ν 6 | 56.03 | 3.492 |
| R12 | 30.92844 | d12= | 0.923 | | | | | 3.850 |
| R13 | −29.34713 | d13= | 0.686 | nd7 | 1.5438 | ν 7 | 56.03 | 4.306 |
| R14 | 2.83383 | d14= | 0.500 | | | | | 4.710 |
| R15 | ∞ | d15= | 0.210 | ndg | 1.5168 | ν g | 64.20 | 5.532 |
| R16 | ∞ | d16= | 0.269 | | | | | 5.597 |

Reference Wavelength = 588 nm

TABLE 2

| | Conic coefficient | Aspherical coefficient | | | |
|---|---|---|---|---|---|
| | k | A4 | A6 | A8 | A10 |
| R1 | 2.0287E−01 | 1.7998E−03 | −1.4221E−02 | 3.3079E−02 | −4.5088E−02 |
| R2 | 0.0000E+00 | 5.5489E−03 | −1.0635E−03 | 7.8365E−03 | −1.1213E−02 |
| R3 | 0.0000E+00 | −1.1558E−02 | 2.6519E−03 | 1.3480E−02 | −2.0700E−02 |
| R4 | 0.0000E+00 | −4.5248E−02 | 1.4690E−01 | −3.7985E−01 | 6.3597E−01 |
| R5 | 0.0000E+00 | −3.9441E−02 | 1.3272E−01 | −3.6938E−01 | 6.0804E−01 |
| R6 | 0.0000E+00 | 6.2250E−04 | −5.2596E−02 | 1.1978E−01 | −1.7676E−01 |
| R7 | 0.0000E+00 | −3.6175E−02 | 4.5233E−02 | −1.7793E−01 | 2.8925E−01 |
| R8 | 0.0000E+00 | 4.7474E−03 | −2.2663E−02 | −8.8012E−03 | 2.6248E−02 |
| R9 | 0.0000E+00 | 1.1092E−02 | −1.3089E−05 | −9.9481E−03 | 9.4867E−03 |
| R10 | 0.0000E+00 | −8.3258E−02 | 2.5723E−02 | −2.0186E−03 | −3.0545E−03 |
| R11 | −1.1031E+00 | −4.3501E−02 | 9.9260E−03 | −4.2048E−03 | 1.1355E−03 |
| R12 | 0.0000E+00 | 4.9707E−02 | −2.3346E−02 | 5.4550E−03 | −8.4115E−04 |
| R13 | 0.0000E+00 | −5.6403E−02 | 1.3522E−02 | −1.7151E−03 | 1.5345E−04 |
| R14 | −1.0418E+01 | −2.5868E−02 | 4.7659E−03 | −5.9622E−04 | 3.9228E−05 |

| | Aspherical coefficient | | | | |
|---|---|---|---|---|---|
| | A12 | A14 | A16 | A18 | A20 |
| R1 | 3.7269E−02 | −1.8955E−02 | 5.7599E−03 | −9.5330E−04 | 6.5246E−05 |
| R2 | 7.6263E−03 | −2.6972E−03 | 3.8384E−04 | 2.7631E−05 | −1.0906E−05 |
| R3 | 1.6719E−02 | −8.2952E−03 | 2.6295E−03 | −4.9281E−04 | 4.1956E−05 |
| R4 | −6.7574E−01 | 4.5725E−01 | −1.9086E−01 | 4.4853E−02 | −4.5395E−03 |
| R5 | −6.2578E−01 | 4.0588E−01 | −1.6164E−01 | 3.6218E−02 | −3.5104E−03 |
| R6 | 1.6720E−01 | −1.0162E−01 | 3.8166E−02 | −8.0255E−03 | 7.1839E−04 |
| R7 | −2.7542E−01 | 1.6237E−01 | −5.8505E−02 | 1.1850E−02 | −1.0412E−03 |
| R8 | −2.0985E−02 | 9.0438E−03 | −2.2298E−03 | 2.9540E−04 | −1.6299E−05 |
| R9 | −4.5471E−03 | 1.2959E−03 | −2.2002E−04 | 1.9923E−05 | −7.1142E−07 |
| R10 | 2.0649E−03 | −6.1288E−04 | 9.5390E−05 | −7.5994E−06 | 2.4534E−07 |
| R11 | −1.8589E−04 | 1.9103E−05 | −1.1952E−06 | 4.1178E−08 | −5.9326E−10 |
| R12 | 8.9384E−05 | −6.4663E−06 | 3.0108E−07 | −8.0581E−09 | 9.3997E−11 |
| R13 | −1.2025E−05 | 8.3034E−07 | −4.0859E−08 | 1.1490E−09 | −1.3532E−11 |
| R14 | −3.9169E−07 | −1.3719E−07 | 1.0404E−08 | −3.2022E−10 | 3.7327E−12 |

TABLE 3

| | |
|---|---|
| 2ω (°) | 82.30 |
| Fno | 1.85 |
| f (mm) | 6.087 |
| f1 (mm) | 6.003 |
| f2 (mm) | −17.400 |
| f3 (mm) | 23.720 |
| f4 (mm) | −47.963 |
| f5 (mm) | −12.144 |
| f6 (mm) | 5.213 |
| f7 (mm) | −4.717 |
| TTL (mm) | 7.197 |
| LB (mm) | 0.979 |
| IH (mm) | 5.600 |

The following Table 16 shows the corresponding values of the parameters defined in the conditions (1) to (7) of the first to fifth embodiments.

As shown in Table 16, the first embodiment satisfies the conditions (1) to (7).

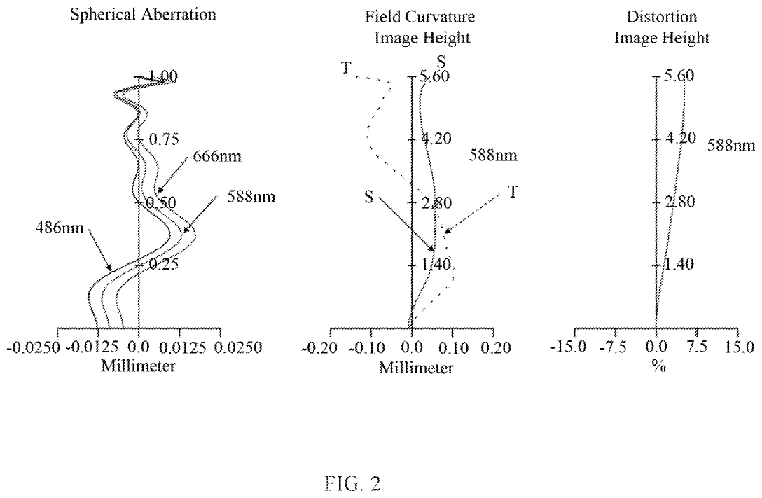

FIG. 2 illustrates a spherical aberration, a field curvature, and a distortion of the camera lens LA according to the first embodiment. In addition, in FIG. 2, S is a field curvature for a sagittal image plane, and T is a field curvature for a meridional image plane, which are the same for the second to fifth embodiments. As shown in FIG. 2, the camera lens LA according to the first embodiment has a wide angle, 2ω=82.30°, and a small height, i.e., TTL/IH=1.285, and good optical characteristics.

### Second Embodiment

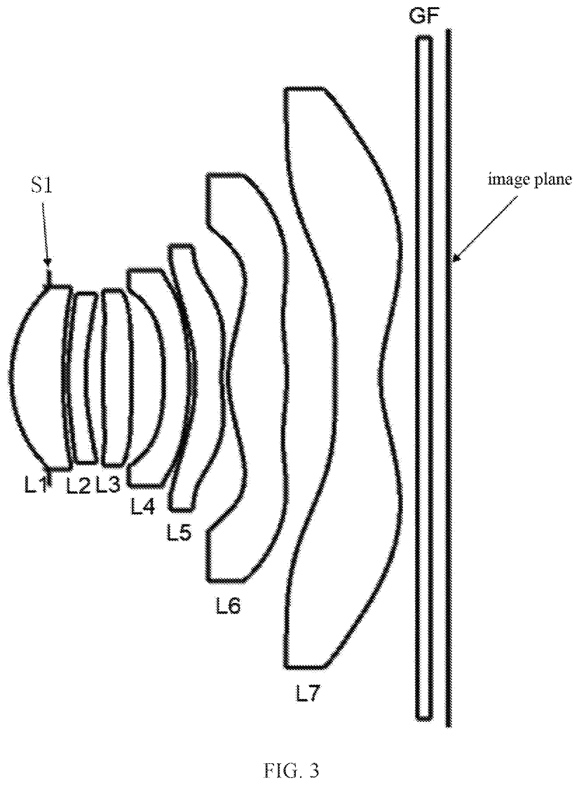

FIG. 3 is a schematic diagram of a camera lens LA according to a second embodiment of the present invention. The curvature radiuses R of the image side surfaces and object side surfaces of the first lens L1 to the seventh lens L7 of the camera lens LA according to the second embodiment, the center thicknesses of the lenses, or distances d between the lenses, refractive indexes nd, abbe numbers v are shown in Table 4; conic coefficients k and aspheric coefficients are shown in Table 5; and 2ω, Fno, f, f1, f2, f3, f4, f5, f6, f7, TTL, and IH are shown in Table 6.

TABLE 4

| | | | | | | | | Effective |
|---|---|---|---|---|---|---|---|---|
| | R | d | | nd | | ν d | | Radius(mm) |
| S1 | ∞ | d0= | −0.606 | | | | | |
| R1 | 2.24651 | d1= | 0.836 | nd1 | 1.4875 | ν 1 | 70.24 | 1.507 |
| R2 | 6.49878 | d2= | 0.080 | | | | | 1.419 |
| R3 | 4.07987 | d3= | 0.285 | nd2 | 1.6653 | ν 2 | 20.23 | 1.393 |
| R4 | 3.46787 | d4= | 0.281 | | | | | 1.310 |
| R5 | 9.98503 | d5= | 0.460 | nd3 | 1.5438 | ν 3 | 56.03 | 1.330 |
| R6 | −52.25510 | d6= | 0.530 | | | | | 1.439 |
| R7 | −4.43245 | d7= | 0.407 | nd4 | 1.6653 | ν 4 | 20.23 | 1.462 |
| R8 | −4.82499 | d8= | 0.095 | | | | | 1.775 |
| R9 | −5.19445 | d9= | 0.431 | nd5 | 1.5661 | ν 5 | 37.71 | 1.923 |
| R10 | 2.36111 | d10= | 0.105 | | | | | 2.176 |
| R11 | 1.73900 | d11= | 0.947 | nd6 | 1.5438 | ν 6 | 56.03 | 2.520 |
| R12 | −3.54131 | d12= | 0.784 | | | | | 3.350 |
| R13 | 184.42865 | d13= | 0.738 | nd7 | 1.5438 | ν 7 | 56.03 | 4.382 |
| R14 | 2.21231 | d14= | 0.600 | | | | | 4.769 |
| R15 | ∞ | d15= | 0.210 | ndg | 1.5168 | ν g | 64.20 | 5.541 |
| R16 | ∞ | d16= | 0.287 | | | | | 5.609 |

Reference Wavelength = 588 nm

TABLE 5

| | Conic coefficient | Aspherical coefficient | | | |
|---|---|---|---|---|---|
| | k | A4 | A6 | A8 | A10 |
| R1 | 4.7307E−01 | 2.9997E−03 | −1.6432E−02 | 3.4272E−02 | −4.4876E−02 |
| R2 | 0.0000E+00 | −6.7773E−02 | 1.2421E−01 | −1.9082E−01 | 2.5551E−01 |
| R3 | 0.0000E+00 | −9.0846E−02 | 6.9870E−02 | −2.7324E−02 | −5.0816E−03 |
| R4 | 0.0000E+00 | −6.5175E−02 | 6.3953E−02 | −1.3518E−01 | 2.8597E−01 |
| R5 | 0.0000E+00 | −2.6381E−02 | 3.9389E−02 | −1.4488E−01 | 2.9481E−01 |
| R6 | 0.0000E+00 | −7.5700E−03 | −4.4323E−02 | 1.1687E−01 | −2.1478E−01 |
| R7 | 0.0000E+00 | −3.3509E−02 | 3.4632E−02 | −1.5250E−01 | 2.0530E−01 |
| R8 | 0.0000E+00 | −5.5261E−03 | −7.2292E−02 | 2.5813E−01 | −3.5606E−01 |
| R9 | 0.0000E+00 | −1.9350E−01 | 1.9868E−01 | 7.1442E−02 | −2.6668E−01 |
| R10 | 0.0000E+00 | −4.8059E−01 | 4.4094E−01 | −3.3390E−01 | 1.8643E−01 |
| R11 | −1.8987E+00 | −1.9376E−01 | 1.7874E−01 | −1.1711E−01 | 5.2160E−02 |
| R12 | 0.0000E+00 | 1.0895E−01 | −2.2396E−02 | −2.7896E−03 | 2.3400E−03 |
| R13 | 0.0000E+00 | −3.9275E−02 | 6.5930E−03 | −5.0526E−04 | 2.3612E−05 |
| R14 | −6.7638E+00 | −2.5125E−02 | 5.2590E−03 | −8.8840E−04 | 9.0161E−05 |

| | Aspherical coefficient | | | | |
|---|---|---|---|---|---|
| | A12 | A14 | A16 | A18 | A20 |
| R1 | 3.7047E−02 | −1.9027E−02 | 5.8153E−03 | −9.4887E−04 | 6.0879E−05 |
| R2 | −2.5774E−01 | 1.7836E−01 | −7.8659E−02 | 1.9755E−02 | −2.1390E−03 |
| R3 | 4.3878E−03 | 9.4805E−03 | −1.1367E−02 | 4.7543E−03 | −7.1550E−04 |
| R4 | −4.0827E−01 | 3.6593E−01 | −1.9806E−01 | 5.9266E−02 | −7.5234E−03 |
| R5 | −3.8146E−01 | 3.1485E−01 | −1.6075E−01 | 4.6271E−02 | −5.7549E−03 |
| R6 | 2.4708E−01 | −1.7894E−01 | 7.9335E−02 | −1.9744E−02 | 2.1088E−03 |
| R7 | −1.6571E−01 | 8.2279E−02 | −2.2644E−02 | 2.3794E−03 | 9.5856E−05 |
| R8 | 2.5691E−01 | −1.0816E−01 | 2.6957E−02 | −3.7134E−03 | 2.1996E−04 |
| R9 | 2.1967E−01 | −9.3648E−02 | 2.2699E−02 | −2.9771E−03 | 1.6460E−04 |
| R10 | −7.3903E−02 | 1.9930E−02 | −3.4068E−03 | 3.2807E−04 | −1.3468E−05 |
| R11 | −1.6269E−02 | 3.4621E−03 | −4.7437E−04 | 3.7434E−05 | −1.2838E−06 |
| R12 | −5.5258E−04 | 7.2265E−05 | −5.5873E−06 | 2.3935E−07 | −4.3860E−09 |
| R13 | −1.4486E−06 | 1.3223E−07 | −7.7741E−09 | 2.2721E−10 | −2.5844E−12 |
| R14 | −4.7680E−06 | 7.3504E−08 | 4.5358E−09 | −2.2886E−10 | 3.0798E−12 |

TABLE 6

| | |
|---|---|
| 2ω (°) | 82.30 |
| Fno | 1.85 |
| f (mm) | 5.564 |
| f1 (mm) | 6.617 |
| f2 (mm) | −42.690 |
| f3 (mm) | 15.456 |
| f4 (mm) | −139.785 |
| f5 (mm) | −2.810 |
| f6 (mm) | 2.289 |
| f7 (mm) | −4.124 |
| TTL (mm) | 7.075 |
| LB (mm) | 1.097 |
| IH (mm) | 5.600 |

As shown in Table 16, the second embodiment satisfies the conditions (1) to (7).

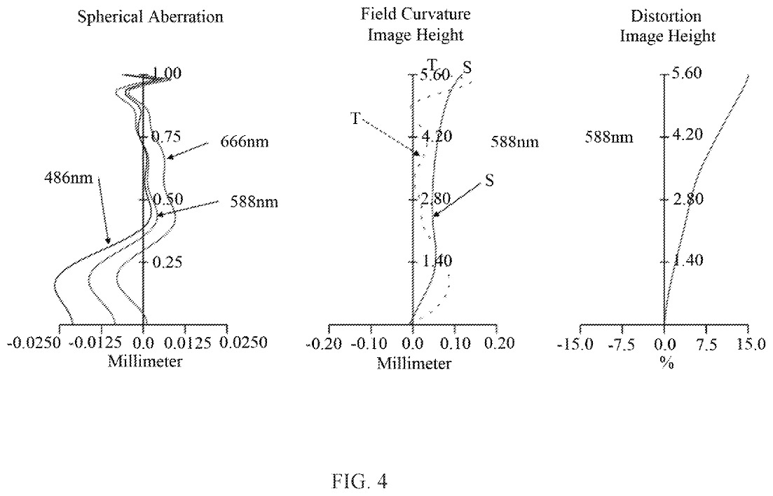

FIG. 4 illustrates a spherical aberration, a field curvature, and a distortion of the camera lens LA according to the second embodiment. As shown in FIG. 4, the camera lens LA according to the second embodiment has a wide angle, 2ω=82.30°, and a small height, i.e., TTL/IH=1.263, and good optical characteristics.

### Third Embodiment

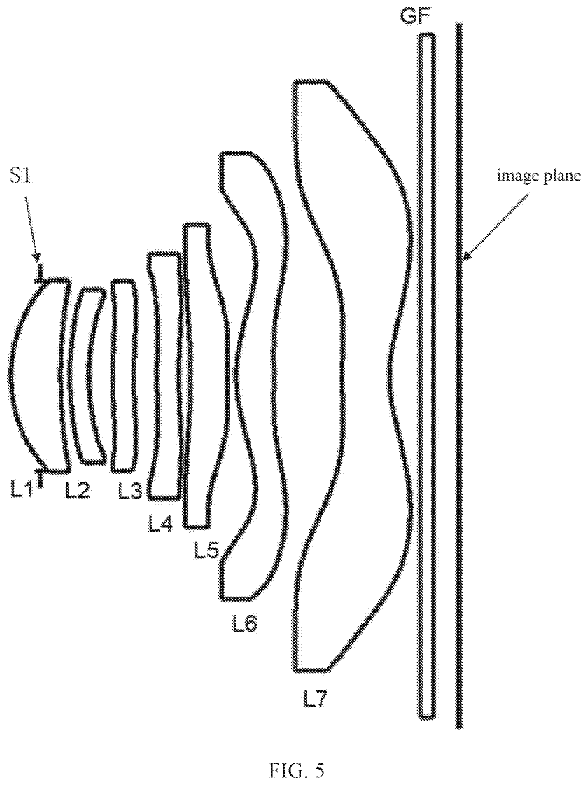

FIG. 5 is a schematic diagram of a camera lens LA according to a third embodiment of the present invention. The curvature radiuses R of the image side surfaces and object side surfaces of the first lens L1 to the seventh lens L7 of the camera lens LA according to the third embodiment, the center thicknesses of the lenses, or distances d between the lenses, refractive indexes nd, abbe numbers v are shown in Table 7; conic coefficients k and aspheric coefficients are shown in Table 8; and 2ω, Fno, f, f1, f2, f3, f4, f5, f6, f7, TTL, and IH are shown in Table 9.

TABLE 7

| | | | | | | | | Effective |
|---|---|---|---|---|---|---|---|---|
| | R | d | | nd | | ν d | | Radius(mm) |
| S1 | ∞ | d0= | −0.465 | | | | | |
| R1 | 2.37708 | d1= | 0.799 | nd1 | 1.4959 | ν 1 | 81.65 | 1.560 |
| R2 | 8.49782 | d2= | 0.148 | | | | | 1.483 |
| R3 | 4.64073 | d3= | 0.306 | nd2 | 1.6700 | ν 2 | 19.39 | 1.419 |
| R4 | 3.62950 | d4= | 0.382 | | | | | 1.310 |
| R5 | 8.29754 | d5= | 0.340 | nd3 | 1.5438 | ν 3 | 56.03 | 1.380 |
| R6 | 8.98669 | d6= | 0.371 | | | | | 1.553 |
| R7 | 13.74282 | d7= | 0.350 | nd4 | 1.6700 | ν 4 | 19.39 | 1.722 |
| R8 | 7.90925 | d8= | 0.184 | | | | | 1.994 |
| R9 | −31.23594 | d9= | 0.590 | nd5 | 1.5661 | ν 5 | 37.71 | 2.194 |
| R10 | 6.25344 | d10= | 0.148 | | | | | 2.474 |
| R11 | 2.34620 | d11= | 0.602 | nd6 | 1.5438 | ν 6 | 56.03 | 3.046 |
| R12 | −24.20777 | d12= | 1.100 | | | | | 3.643 |
| R13 | 9.71370 | d13= | 0.757 | nd7 | 1.5438 | ν 7 | 56.03 | 4.495 |
| R14 | 2.25899 | d14= | 0.500 | | | | | 4.802 |
| R15 | ∞ | d15= | 0.210 | ndg | 1.5168 | ν g | 64.20 | 5.502 |
| R16 | ∞ | d16= | 0.410 | | | | | 5.564 |

Reference Wavelength = 588 nm

TABLE 8

| | Conic coefficient | Aspherical coefficient | | | |
|---|---|---|---|---|---|
| | k | A4 | A6 | A8 | A10 |
| R1 | 3.2685E−01 | 3.2610E−03 | −1.5840E−02 | 3.4060E−02 | −4.5018E−02 |
| R2 | 0.0000E+00 | −3.0865E−04 | −3.8836E−02 | 1.1703E−01 | −1.7968E−01 |
| R3 | 0.0000E+00 | −4.3070E−02 | 1.0674E−01 | −2.5610E−01 | 4.1067E−01 |
| R4 | 0.0000E+00 | −2.1784E−02 | 4.5020E−02 | −1.7391E−01 | 4.4374E−01 |
| R5 | 0.0000E+00 | −2.9977E−02 | 3.6085E−02 | −1.6092E−01 | 3.7507E−01 |
| R6 | 0.0000E+00 | −4.5202E−02 | 9.7855E−02 | −2.3782E−01 | 3.5415E−01 |
| R7 | 0.0000E+00 | −2.9489E−02 | −2.1035E−02 | 3.4804E−02 | −3.4290E−02 |
| R8 | 0.0000E+00 | −3.9016E−02 | 2.2532E−02 | −1.8030E−02 | 7.5363E−03 |
| R9 | 0.0000E+00 | −6.8375E−02 | 8.8549E−02 | −6.1049E−02 | 2.6388E−02 |
| R10 | 0.0000E+00 | −1.9057E−01 | 1.1478E−01 | −5.0748E−02 | 1.6708E−02 |
| R11 | −1.8761E+00 | −6.5529E−02 | 3.6092E−02 | −1.6923E−02 | 4.7568E−03 |
| R12 | 0.0000E+00 | 8.4764E−02 | −3.6024E−02 | 7.6362E−03 | −9.0473E−04 |
| R13 | 0.0000E+00 | −5.6951E−02 | 1.2349E−02 | −2.0515E−03 | 2.7631E−04 |
| R14 | −5.6745E+00 | −2.8053E−02 | 6.2110E−03 | −1.0809E−03 | 1.3143E−04 |

| | Aspherical coefficient | | | | |
|---|---|---|---|---|---|
| | A12 | A14 | A16 | A18 | A20 |
| R1 | 3.7141E−02 | −1.9020E−02 | 5.7906E−03 | −9.3586E−04 | 5.9064E−05 |
| R2 | 1.6876E−01 | −9.9180E−02 | 3.5547E−02 | −7.0825E−03 | 5.9622E−04 |
| R3 | −4.0906E−01 | 2.5457E−01 | −9.6248E−02 | 2.0244E−02 | −1.8264E−03 |
| R4 | −6.4127E−01 | 5.5184E−01 | −2.8043E−01 | 7.7964E−02 | −9.1673E−03 |
| R5 | −5.2008E−01 | 4.3592E−01 | −2.1736E−01 | 5.9474E−02 | −6.8806E−03 |
| R6 | −3.3465E−01 | 2.0022E−01 | −7.3554E−02 | 1.5159E−02 | −1.3449E−03 |
| R7 | 2.3292E−02 | −9.7397E−03 | 2.3224E−03 | −2.7658E−04 | 1.0797E−05 |
| R8 | −4.4713E−04 | −8.3537E−04 | 3.4991E−04 | −5.9766E−05 | 3.9073E−06 |
| R9 | −7.1994E−03 | 1.1823E−03 | −9.9898E−05 | 1.8933E−06 | 1.8307E−07 |
| R10 | −3.6926E−03 | 5.0885E−04 | −3.9367E−05 | 1.2836E−06 | 2.3018E−09 |
| R11 | −8.0078E−04 | 7.6122E−05 | −3.3410E−06 | 6.8957E−09 | 2.8854E−09 |
| R12 | 4.3863E−05 | 2.5549E−06 | −4.8416E−07 | 2.5856E−08 | −4.9842E−10 |
| R13 | −2.6012E−05 | 1.5795E−06 | −5.8744E−08 | 1.2176E−09 | −1.0775E−11 |
| R14 | −1.0912E−05 | 5.8793E−07 | −1.9128E−08 | 3.3433E−10 | −2.3556E−12 |

TABLE 9

| | |
|---|---|
| 2ω (°) | 81.48 |
| Fno | 1.90 |
| f (mm) | 5.905 |
| f1 (mm) | 6.379 |
| f2 (mm) | −28.301 |
| f3 (mm) | 169.496 |
| f4 (mm) | −28.497 |
| f5 (mm) | −9.152 |
| f6 (mm) | 3.965 |
| f7 (mm) | −5.614 |
| TTL (mm) | 7.197 |
| LB (mm) | 1.120 |
| IH (mm) | 5.600 |

As shown in Table 16, the third embodiment satisfies the conditions (1) to (7).

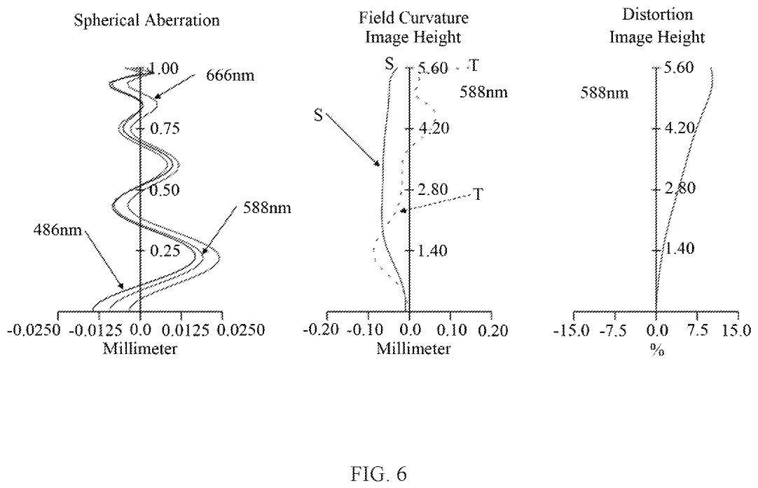

FIG. 6 illustrates a spherical aberration, a field curvature, and a distortion of the camera lens LA according to the third embodiment. As shown in FIG. 6, the camera lens LA according to the third embodiment has a wide angle, 2ω=81.48°, and a small height, i.e., TTL/IH=1.285, and good optical characteristics.

### Fourth Embodiment

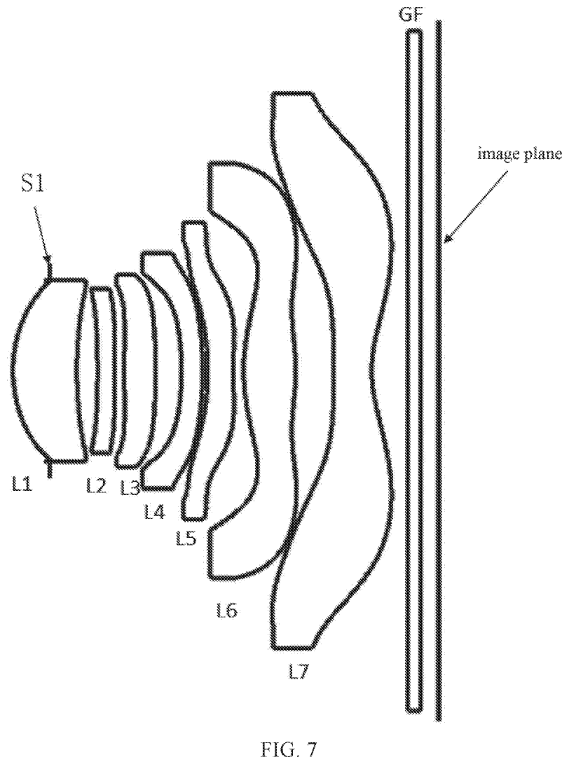

FIG. 7 is a schematic diagram of a camera lens LA according to a fourth embodiment of the present invention. The curvature radiuses R of the image side surfaces and object side surfaces of the first lens L1 to the seventh lens L7 of the camera lens LA according to the fourth embodiment, the center thicknesses of the lenses, or distances d between the lenses, refractive indexes nd, abbe numbers v are shown in Table 10; conic coefficients k and aspheric coefficients are shown in Table 11; and 2ω, Fno, f, f1, f2, f3, f4, f5, f6, f7, TTL, and IH are shown in Table 12.

TABLE 10

| | | | | | | | | Effective |
|---|---|---|---|---|---|---|---|---|
| | R | d | | nd | | ν d | | Radius(mm) |
| S1 | ∞ | d0= | −0.611 | | | | | |
| R1 | 2.18552 | d1= | 1.057 | nd1 | 1.4959 | ν 1 | 81.65 | 1.493 |
| R2 | 7.30436 | d2= | 0.340 | | | | | 1.361 |
| R3 | −19.19917 | d3= | 0.285 | nd2 | 1.6797 | ν 2 | 18.42 | 1.344 |
| R4 | −480.14724 | d4= | 0.157 | | | | | 1.340 |
| R5 | 29.80546 | d5= | 0.519 | nd3 | 1.5438 | ν 3 | 56.03 | 1.392 |
| R6 | −10.37748 | d6= | 0.427 | | | | | 1.573 |
| R7 | −5.02114 | d7= | 0.350 | nd4 | 1.6797 | ν 4 | 18.42 | 1.612 |
| R8 | −6.53376 | d8= | 0.080 | | | | | 1.925 |
| R9 | −7.88032 | d9= | 0.423 | nd5 | 1.5661 | ν 5 | 37.71 | 2.120 |
| R10 | 5.25355 | d10= | 0.172 | | | | | 2.442 |
| R11 | 3.12801 | d11= | 0.859 | nd6 | 1.5438 | ν 6 | 56.03 | 2.617 |
| R12 | −3.51960 | d12= | 0.622 | | | | | 3.397 |
| R13 | 63.82499 | d13= | 0.633 | nd7 | 1.5438 | ν 7 | 56.03 | 4.200 |
| R14 | 2.04288 | d14= | 0.600 | | | | | 4.550 |
| R15 | ∞ | d15= | 0.210 | ndg | 1.5168 | ν g | 64.20 | 5.495 |
| R16 | ∞ | d16= | 0.300 | | | | | 5.570 |

Reference Wavelength = 588 nm

TABLE 11

| | Conic coefficient | Aspherical coefficient | | | |
|---|---|---|---|---|---|
| | k | A4 | A6 | A8 | A10 |
| R1 | 3.5279E−01 | 2.8324E−03 | −1.4914E−02 | 3.3697E−02 | −4.5049E−02 |
| R2 | 0.0000E+00 | −5.3778E−03 | 6.4702E−02 | −1.9292E−01 | 3.5853E−01 |
| R3 | 0.0000E+00 | −1.1132E−02 | −1.6837E−02 | −2.3578E−02 | 1.6190E−01 |
| R4 | 0.0000E+00 | −2.4344E−02 | 3.3124E−02 | −1.4825E−01 | 3.0220E−01 |
| R5 | 0.0000E+00 | −2.2879E−02 | 8.2300E−02 | −3.4062E−01 | 6.9407E−01 |
| R6 | 0.0000E+00 | −1.4954E−04 | −1.9574E−02 | 2.6761E−02 | −3.3776E−02 |
| R7 | 0.0000E+00 | −6.6646E−02 | 1.9643E−01 | −4.6427E−01 | 6.1309E−01 |
| R8 | 0.0000E+00 | −9.0449E−02 | 2.0516E−01 | −2.4901E−01 | 1.8406E−01 |
| R9 | 0.0000E+00 | −1.8969E−01 | 2.4810E−01 | −1.6224E−01 | 4.9663E−02 |
| R10 | 0.0000E+00 | −1.7267E−01 | 3.1379E−02 | 3.7456E−02 | −4.2112E−02 |
| R11 | −2.2288E+00 | −9.3583E−03 | −2.4032E−02 | 2.5383E−02 | −1.5084E−02 |
| R12 | 0.0000E+00 | 9.7402E−02 | −7.9931E−03 | −9.7316E−03 | 4.2717E−03 |
| R13 | 0.0000E+00 | −4.6673E−02 | 4.0024E−03 | 1.2330E−03 | −3.3993E−04 |
| R14 | −4.5352E+00 | −4.0470E−02 | 1.0447E−02 | −2.0606E−03 | 2.7493E−04 |

| | Aspherical coefficient | | | | |
|---|---|---|---|---|---|
| | A12 | A14 | A16 | A18 | A20 |
| R1 | 3.7245E−02 | −1.8965E−02 | 5.7804E−03 | −9.5821E−04 | 6.6256E−05 |
| R2 | −4.2716E−01 | 3.2771E−01 | −1.5691E−01 | 4.2700E−02 | −5.0429E−03 |
| R3 | −3.2212E−01 | 3.3341E−01 | −1.9346E−01 | 5.9874E−02 | −7.7130E−03 |
| R4 | −3.6899E−01 | 2.7989E−01 | −1.2873E−01 | 3.3069E−02 | −3.6468E−03 |
| R5 | −8.6796E−01 | 6.7548E−01 | −3.1963E−01 | 8.4345E−02 | −9.5472E−03 |
| R6 | 2.4319E−02 | −1.0937E−02 | 2.9766E−03 | −4.8372E−04 | 4.0328E−05 |
| R7 | −5.1724E−01 | 2.8078E−01 | −9.5155E−02 | 1.8297E−02 | −1.5146E−03 |
| R8 | −9.1667E−02 | 3.0563E−02 | −6.4778E−03 | 7.8681E−04 | −4.1590E−05 |
| R9 | −4.2083E−04 | −4.4394E−03 | 1.3657E−03 | −1.7824E−04 | 8.9949E−06 |
| R10 | 2.0518E−02 | −5.4252E−03 | 8.0369E−04 | −6.2941E−05 | 2.0360E−06 |
| R11 | 5.0534E−03 | −9.9680E−04 | 1.1430E−04 | −6.9988E−06 | 1.7558E−07 |
| R12 | −8.8157E−04 | 1.0701E−04 | −7.8140E−06 | 3.1879E−07 | −5.6039E−09 |
| R13 | 3.8069E−05 | −2.3646E−06 | 8.5082E−08 | −1.6655E−09 | 1.3768E−11 |
| R14 | −2.4356E−05 | 1.3897E−06 | −4.8529E−08 | 9.3982E−10 | −7.7274E−12 |

TABLE 12

| | |
|---|---|
| 2ω (°) | 84.18 |
| Fno | 1.85 |
| f (mm) | 5.504 |
| f1 (mm) | 5.886 |
| f2 (mm) | −29.428 |
| f3 (mm) | 14.220 |
| f4 (mm) | −35.203 |
| f5 (mm) | −5.504 |
| f6 (mm) | 3.191 |
| f7 (mm) | −3.895 |
| TTL (mm) | 7.034 |
| LB (mm) | 1.110 |
| IH (mm) | 5.600 |

As shown in Table 16, the fourth embodiment satisfies the conditions (1) to (7).

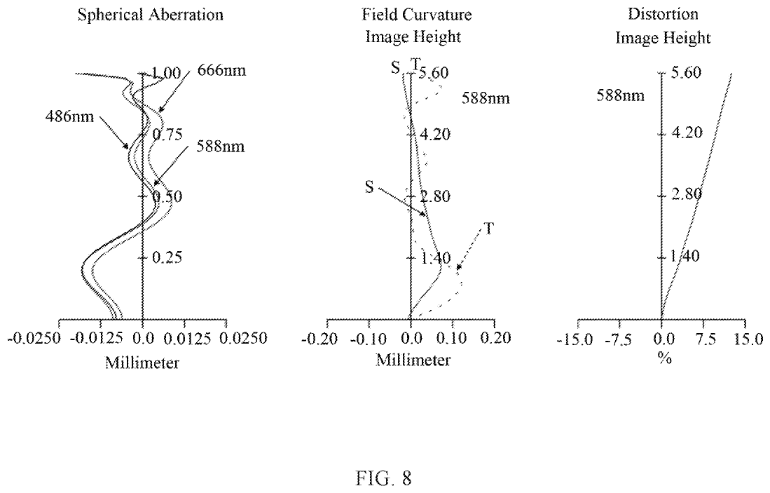

FIG. 8 illustrates a spherical aberration, a field curvature, and a distortion of the camera lens LA according to the fourth embodiment. As shown in FIG. 8, the camera lens LA according to the fourth embodiment has a wide angle, 2ω=84.18°, and a small height, i.e., TTL/IH=1.256, and good optical characteristics.

### Fifth Embodiment

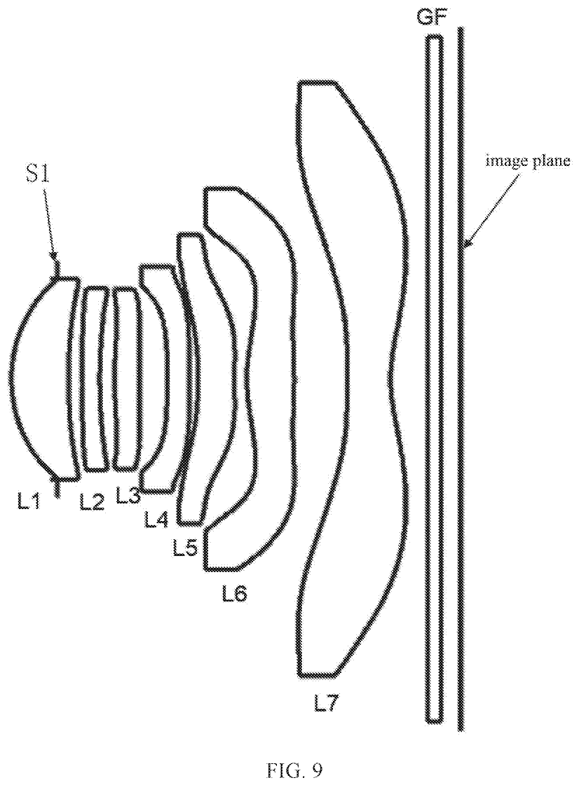

FIG. 9 is a schematic diagram of a camera lens LA according to a fifth embodiment of the present invention. The curvature radiuses R of the image side surfaces and object side surfaces of the first lens L1 to the seventh lens L7 of the camera lens LA according to the fifth embodiment, the center thicknesses of the lenses, or distances d between the lenses, refractive indexes nd, abbe numbers v are shown in Table 13; conic coefficients k and aspheric coefficients are shown in Table 14; and 2ω, Fno, f, f1, f2, f3, f4, f5, f6, f7, TTL, and IH are shown in Table 15.

TABLE 13

| | | | | | | | | Effective |
|---|---|---|---|---|---|---|---|---|
| | R | d | | nd | | ν d | | Radius(mm) |
| S1 | ∞ | d0= | −0.725 | | | | | |
| R1 | 2.26413 | d1= | 0.913 | nd1 | 1.5267 | ν 1 | 76.60 | 1.643 |
| R2 | 9.05641 | d2= | 0.215 | | | | | 1.544 |
| R3 | 21.69120 | d3= | 0.285 | nd2 | 1.6610 | ν 2 | 20.53 | 1.494 |
| R4 | 7.71389 | d4= | 0.240 | | | | | 1.380 |
| R5 | 7.41543 | d5= | 0.390 | nd3 | 1.5438 | ν 3 | 56.03 | 1.380 |
| R6 | 16.61484 | d6= | 0.454 | | | | | 1.478 |
| R7 | −14.36045 | d7= | 0.350 | nd4 | 1.6610 | ν 4 | 20.53 | 1.522 |
| R8 | 19.42948 | d8= | 0.137 | | | | | 1.847 |
| R9 | −28.24300 | d9= | 0.588 | nd5 | 1.5661 | ν 5 | 37.71 | 2.019 |
| R10 | 7.43237 | d10= | 0.197 | | | | | 2.359 |
| R11 | 2.78797 | d11= | 0.758 | nd6 | 1.5438 | ν 6 | 56.03 | 2.484 |
| R12 | −7.62492 | d12= | 0.848 | | | | | 3.120 |
| R13 | −262.18923 | d13= | 0.696 | nd7 | 1.5438 | ν 7 | 56.03 | 4.542 |
| R14 | 2.40786 | d14= | 0.600 | | | | | 4.852 |
| R15 | ∞ | d15= | 0.210 | ndg | 1.5168 | ν g | 64.20 | 5.543 |
| R16 | ∞ | d16= | 0.317 | | | | | 5.603 |

Reference Wavelength = 588 nm

TABLE 14

| | Conic coefficient | Aspherical coefficient | | | |
|---|---|---|---|---|---|
| | k | A4 | A6 | A8 | A10 |
| R1 | 2.7150E−01 | 1.3652E−03 | −1.2935E−02 | 3.2656E−02 | −4.5049E−02 |
| R2 | 0.0000E+00 | 8.7622E−03 | −2.7004E−02 | 7.1319E−02 | −1.0988E−01 |
| R3 | 0.0000E+00 | −1.8019E−02 | 4.4883E−02 | −9.8493E−02 | 1.6265E−01 |
| R4 | 0.0000E+00 | −3.1746E−02 | 6.5715E−02 | −1.4718E−01 | 2.4173E−01 |
| R5 | 0.0000E+00 | −2.4949E−02 | −6.5980E−02 | 2.6310E−01 | −5.8519E−01 |
| R6 | 0.0000E+00 | −3.0246E−03 | −9.4007E−02 | 2.7540E−01 | −4.9543E−01 |
| R7 | 0.0000E+00 | −3.9585E−02 | −3.3905E−02 | 1.2131E−01 | −2.1908E−01 |
| R8 | 0.0000E+00 | −1.3203E−01 | 1.6505E−01 | −1.5815E−01 | 1.0082E−01 |
| R9 | 0.0000E+00 | −2.0455E−01 | 2.1986E−01 | −1.5363E−01 | 8.9930E−02 |
| R10 | 0.0000E+00 | −2.3172E−01 | 1.3208E−01 | −5.2083E−02 | 1.3155E−02 |
| R11 | −4.5474E+00 | −5.9169E−02 | 1.1566E−02 | 4.4146E−03 | −5.1905E−03 |
| R12 | 0.0000E+00 | 7.9036E−02 | −3.9235E−02 | 1.3338E−02 | −3.8432E−03 |
| R13 | 0.0000E+00 | −5.7973E−02 | 2.0286E−02 | −4.0299E−03 | 4.9990E−04 |
| R14 | −9.6291E+00 | −2.8407E−02 | 6.9922E−03 | −1.1787E−03 | 1.2411E−04 |

| | Aspherical coefficient | | | | |
|---|---|---|---|---|---|
| | A12 | A14 | A16 | A18 | A20 |
| R1 | 3.7341E−02 | −1.8968E−02 | 5.7606E−03 | −9.5369E−04 | 6.5314E−05 |
| R2 | 1.0711E−01 | −6.6159E−02 | 2.4994E−02 | −5.2651E−03 | 4.7339E−04 |
| R3 | −1.7169E−01 | 1.1302E−01 | −4.4727E−02 | 9.7080E−03 | −8.8262E−04 |
| R4 | −2.5315E−01 | 1.6544E−01 | −6.4291E−02 | 1.3269E−02 | −1.0589E−03 |
| R5 | 7.7518E−01 | −6.2860E−01 | 3.0579E−01 | −8.2042E−02 | 9.3447E−03 |
| R6 | 5.4869E−01 | −3.7832E−01 | 1.5807E−01 | −3.6698E−02 | 3.6406E−03 |
| R7 | 2.0512E−01 | −1.0930E−01 | 3.2587E−02 | −4.8383E−03 | 2.5104E−04 |
| R8 | −4.2933E−02 | 1.1315E−02 | −1.6331E−03 | 1.0650E−04 | −1.9344E−06 |
| R9 | −4.4108E−02 | 1.5683E−02 | −3.5287E−03 | 4.4055E−04 | −2.3176E−05 |
| R10 | −1.5043E−03 | −2.5667E−05 | 1.5997E−05 | 9.1125E−08 | −1.0649E−07 |
| R11 | 1.6169E−03 | −1.6484E−04 | −1.9797E−05 | 5.8220E−06 | −3.6033E−07 |
| R12 | 8.3134E−04 | −1.2222E−04 | 1.1288E−05 | −5.8495E−07 | 1.2902E−08 |
| R13 | −3.9739E−05 | 2.0308E−06 | −6.4697E−08 | 1.1715E−09 | −9.2158E−12 |
| R14 | −8.0715E−06 | 3.1249E−07 | −6.4606E−09 | 4.9566E−11 | 1.5177E−13 |

TABLE 15

| | |
|---|---|
| 2ω (°) | 80.98 |
| Fno | 1.85 |
| f (mm) | 6.078 |
| f1 (mm) | 5.478 |
| f2 (mm) | −18.260 |
| f3 (mm) | 24.266 |
| f4 (mm) | −12.442 |
| f5 (mm) | −10.333 |
| f6 (mm) | 3.853 |
| f7 (mm) | −4.384 |
| TTL (mm) | 7.197 |
| LB (mm) | 1.127 |
| IH (mm) | 5.600 |

As shown in Table 16, the fifth embodiment satisfies the conditions (1) to (7).

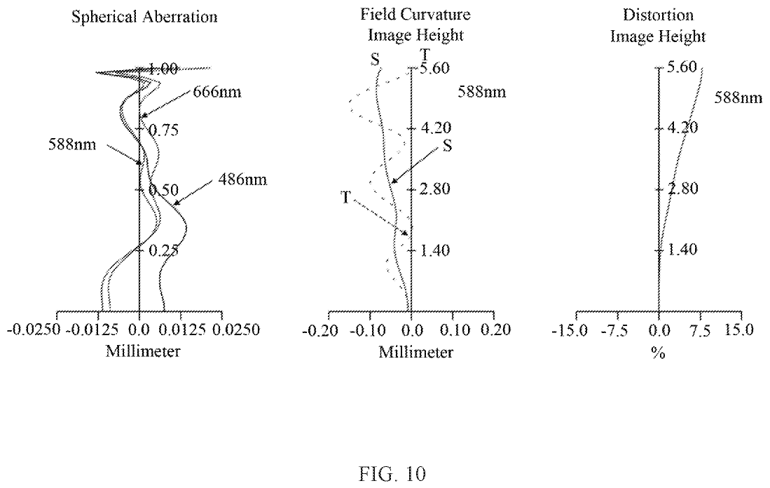

FIG. 10 illustrates a spherical aberration, a field curvature, and a distortion of the camera lens LA according to the fifth embodiment. As shown in FIG. 10, the camera lens LA according to the fifth embodiment has a wide angle, 2ω=80.98°, and a small height, i.e., TTL/IH=1.285, and good optical characteristics.

Table 16 shows the values of the parameter defined in the conditions (1) to (7) of the first to fifth embodiments.

TABLE 16

| | Embodiment 1 | Embodiment 2 | Embodiment 3 | Embodiment 4 | Embodiment 5 | Notes |
|---|---|---|---|---|---|---|
| DMI | 5.030 | 14.793 | 9.938 | 12.259 | 7.671 | condition (1) |
| ν 1 − ν 3 | 69.941 | 50.011 | 62.262 | 63.235 | 56.075 | condition (2) |
| ν 1 − ν 4 | 69.941 | 50.011 | 62.262 | 63.235 | 56.075 | condition (3) |
| f1/f2 | −0.345 | −0.155 | −0.225 | −0.200 | −0.300 | condition (4) |
| f5/f | −1.995 | −0.505 | −1.550 | −1.000 | −1.700 | condition (5) |
| R9/R10 | −0.205 | −2.200 | −4.995 | −1.500 | −3.800 | condition (6) |
| R1/R2 | 0.205 | 0.346 | 0.280 | 0.299 | 0.250 | condition (7) |

What is claimed is:

1. A camera lens, comprising, sequentially from an object side:
a first lens having a positive refractive power;
a second lens having a negative refractive power;
a third lens having a positive refractive power;
a fourth lens having a negative refractive power;
a fifth lens having a negative refractive power;
a sixth lens having a positive refractive power; and
a seventh lens having a negative refractive power,
wherein the camera lens satisfies following conditions:
5.00≤DMI≤15.00;
50.00≤v1-v2≤70.00;
50.00≤v1-v4≤70.00;
−0.35≤f1/f2≤−0.15; and
−2.00≤f5/f≤−0.50,
where
DMI denotes a distortion of a maximum image height;
v1 denotes an abbe number of the first lens;
v2 denotes an abbe number of the second lens;
v4 denotes an abbe number of the fourth lens;
f denotes a focal length of the camera lens;
f1 denotes a focal length of the first lens;
f2 denotes a focal length of the second lens; and
f5 denotes a focal length of the fifth lens.

2. The camera lens as described in claim 1, further satisfying a following condition:
−5.00≤R9/R10≤−0.20,
where
R9 denotes a curvature radius of an object side surface of the fifth lens; and
R10 denotes a curvature radius of an image side surface of the fifth lens.

3. The camera lens as described in claim 1, further satisfying a following condition:
0.02≤R1/R2≤0.35,
where
R1 denotes a curvature radius of an object side surface of the first lens; and
R2 denotes a curvature radius of an image side surface of the first lens.
